(19) United States
(12) Patent Application Publication
(10) Pub. No.: US 2013/0025249 A1
(43) Pub. Date: Jan. 31, 2013

(54) ANODIZED ALUMINUM COTTON HARVESTER SPINDLE NUT

(71) Applicants: Kevin J. Goering, Cambridge, IA (US); Mark S. Philips, Akron, IA (US); Jeffrey R. Fox, Minburn, IA (US)

(72) Inventors: Kevin J. Goering, Cambridge, IA (US); Mark S. Philips, Akron, IA (US); Jeffrey R. Fox, Minburn, IA (US)

(21) Appl. No.: 13/192,549

(22) Filed: Jul. 28, 2011

(51) Int. Cl. A01D 46/18

(52) U.S. Cl. 56/50

(57) ABSTRACT

A spindle assembly for a cotton harvester. The spindle assembly includes an elongated nut having a first end with a threaded portion configured for receipt by the spindle bar. The elongated nut also has a second end, opposite the first end, with a tool receiving portion configured to be received by a tool to tighten the threaded portion of the first end into the spindle bar. The elongated nut further has an aperture extending through the elongated nut from the first end to the second end. The spindle assembly also includes a cotton harvester spindle having a bearing portion rotatably supported by the aperture of the elongated nut and a picking end projecting outwardly from the second end of the elongated nut. The elongated nut is hard coat anodized to improve wear resistance.

### FIELD OF THE INVENTION

The present invention generally relates to cotton harvester spindle assemblies, and more particularly to spindle nuts for cotton harvester spindle assemblies.

### BACKGROUND OF THE INVENTION

In order to harvest cotton, cotton harvesters commonly include two to six forwardly-located row units. Each row unit supports a pair of upright drums in a cam track. The upright drums have from twelve to sixteen spindle bars. Each spindle bar, in turn, rotatably supports up to twenty cotton harvester spindles.

Each spindle is supported in the spindle bar by an assembly including a threaded metal nut having a cylindrically-shaped aperture and a two-piece metal bushing pressed into opposite ends of the aperture. The threaded metal nut is manufactured by machining a hex bar. The spindle is inserted into the two-piece bushing and a dust collar is placed over the spindle adjacent the outer end of the nut. The opposite end of the nut is then threaded into the spindle bar so that a spindle bevel gear meshes with a similar bevel gear on a drive shaft that extends through the spindle bar. Such a spindle assembly is shown, for example, in U.S. Pat. No. 4,757,671, which is of common ownership with the present invention. In operation, a large amount of mass is put into motion when the picker drums are rotated.

Alternatively, each spindle may be supported by an assembly including a plastic nut and a single elongated bushing extending substantially the entire length of the plastic nut. Such a spindle assembly is shown, for example, in U.S. Pat. No. 5,394,680, which is also of common ownership with the present invention.

### SUMMARY OF THE INVENTION

In one embodiment, the invention provides a spindle assembly for a cotton harvester. The spindle assembly includes an elongated nut having a first end with a threaded portion configured for receipt by the spindle bar. The elongated nut also has a second end, opposite the first end, with a tool receiving portion configured to be received by a tool to tighten the threaded portion of the first end into the spindle bar. The elongated nut further has an aperture extending through the elongated nut from the first end to the second end. The spindle assembly also includes a cotton harvester spindle having a bearing portion rotatably supported by the aperture of the elongated nut and a picking end projecting outwardly from the second end of the elongated nut. The elongated nut is hard coat anodized to improve wear resistance.

In another embodiment, the invention provides a spindle assembly for a cotton harvester. The spindle assembly includes an elongated nut having a first end with a threaded portion configured for receipt by the spindle bar. The elongated nut also has a second end, opposite the first end, with a tool receiving portion configured to be received by a tool to tighten the threaded portion of the first end into the spindle bar. The elongated nut further has an aperture extending through the elongated nut from the first end to the second end. The elongated nut further yet has a lubricant groove extending along the aperture from the first end towards the second end. The spindle assembly also includes a cotton harvester spindle having a bearing portion rotatably supported by the aperture of the elongated nut and a picking end projecting outwardly from the second end of the elongated nut. The elongated nut is hard coat anodized to improve wear resistance.

In yet another embodiment, the invention provides a spindle assembly for a cotton harvester. The spindle assembly includes an elongated nut having a first end with a threaded portion configured for receipt by the spindle bar. The elongated nut also has a second end, opposite the first end, with a tool receiving portion configured to be received by a tool to tighten the threaded portion of the first end into the spindle bar. The elongated nut further has an aperture extending through the elongated nut from the first end to the second end. The elongated nut also has a lubricant groove extending along the aperture from the first end towards the second end. The elongated nut further has a notch in the first end in fluid communication with the lubricant groove. The elongated nut also has a lubricant cavity positioned between the first end and the second end and in fluid communication with the lubricant groove. The spindle assembly also includes a cotton harvester spindle having a bearing portion rotatably supported by the aperture of the elongated nut and a picking end projecting outwardly from the second end of the elongated nut. The elongated nut is hard coat anodized to improve wear resistance.

Other features and aspects of the invention will become apparent by consideration of the detailed description and accompanying drawings.

### BRIEF DESCRIPTION OF THE DRAWINGS

FIG. 1 is a perspective view of a cotton harvester spindle assembly according to one embodiment of the invention.

FIG. 2 is an elevational view of the cotton harvester spindle assembly shown in FIG. 1.

FIG. 3 is a cross-sectional view of the cotton harvester spindle assembly shown in FIG. 2.

FIG. 4 is an end view of an elongated nut of the cotton harvester spindle assembly shown in FIG. 1.

FIG. 5 is a cross-sectional view of an elongated nut of a cotton picker spindle assembly according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

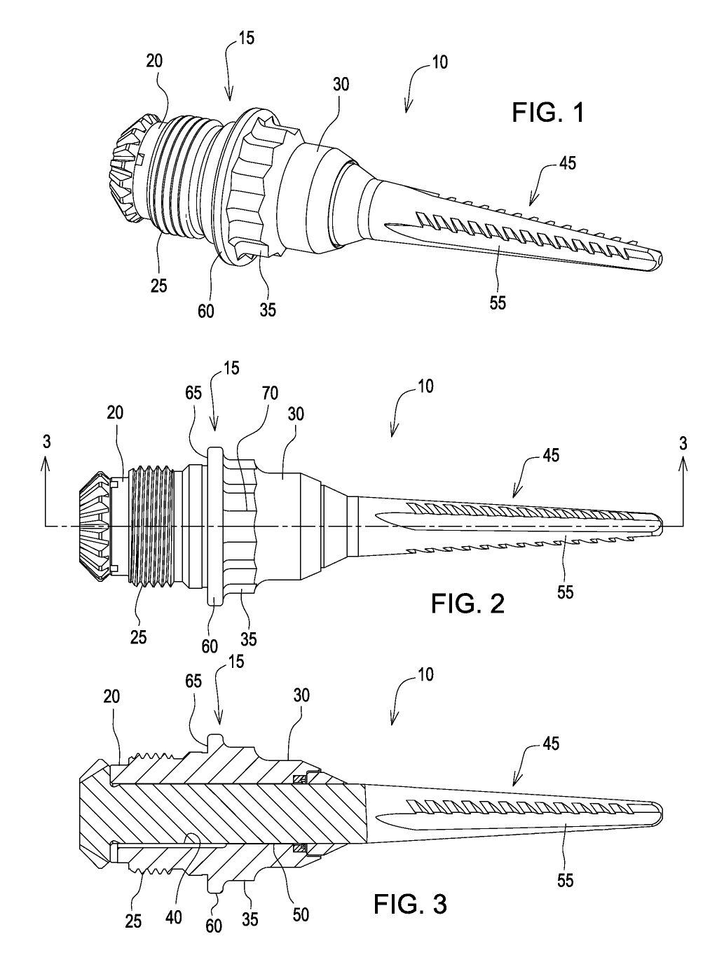

FIGS. 1-4 illustrate a cotton harvester spindle assembly 10. The illustrated spindle assembly 10 includes a one piece elongated nut 15. The elongated nut 15 has a first end 20 with a threaded portion 25. The elongated nut 15 has a second end 30, opposite the first end 20, with a tool receiving portion 35. Referring to FIG. 3, the elongated nut 15 also has an aperture 40 extending through the elongated nut 15 from the first end 20 to the second end 30.

The elongated nut 15 is fabricated from aluminum, magnesium, or other metal or metal alloy that is lighter than steel. Alternatively, the elongated nut 15 is fabricated from a metal or metal alloy that is lighter than a plastic nut with a powdered metal bushing. The elongated nut 15 is hard coat anodized for improved durability of the aperture 40 and improved wear resistance to abrasive crop material. Alternatively, other specialized abrasive and corrosion resistant coatings are used such as Tufram® from the General Magnaplate Corporation of Linden, N.J. The elongated nut 15 is cold formed to create most of the features and to minimize waste. After cold forming, the threaded portion 25 and the aperture 40 are machined into the elongated nut 15. Alternatively, the elongated nut 15 is completely machined.

As illustrated in FIGS. 1-4, the spindle assembly 10 also includes a cotton harvester spindle 45. Referring to FIG. 3, the cotton harvester spindle 45 has a bearing portion 50 that is rotatably supported by the aperture 40 of the elongated nut 15. The cotton harvester spindle 45 also has a picking end 55 that projects outwardly from the second end 30 of the elongated nut 15.

FIGS. 1-4 illustrate the cotton harvester spindle assembly 10 further includes a flange 60. As shown in FIGS. 2-4, the flange 60 has a mating surface 65 that contacts a spindle bar (not shown). Opposite the mating surface 65, the flange 60 is coupled to the tool receiving portion 35 that has a twelve-point drive profile 70. Alternatively, the tool receiving portion 35 has a hex or other drive profile (not shown).

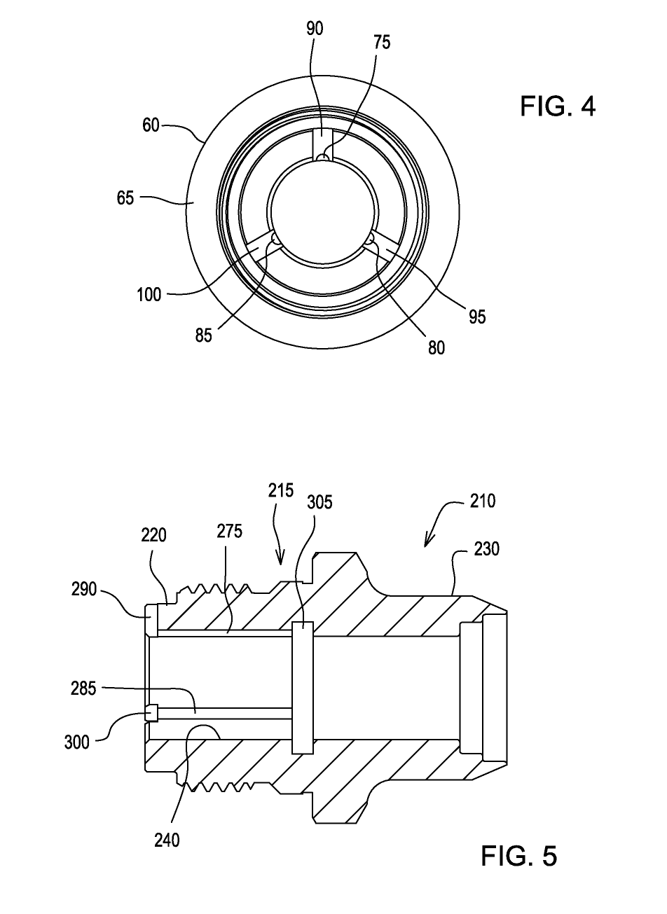

Referring to FIG. 4, the cotton harvester spindle assembly 10 further yet includes a lubricant groove 75. In the illustrated embodiment, three lubricant grooves 75, 80, 85 are shown. The lubricant grooves 75, 80, 85 extend along the aperture 40 from the first end 20 of the elongated nut 15 towards the second end 30.

The cotton harvester spindle assembly 10 further includes a notch 90. In the illustrated embodiment, three notches 90, 95, 100 are shown. The notches 90, 95, 100 are formed in the first end 20 of the elongated nut 15 and are in fluid communication with the corresponding lubricant grooves 75, 80, 85.

During assembly, the cotton harvester spindle 45 is positioned such that the bearing portion 50 is rotatably supported by the aperture 40 of the elongated nut 15 and the picking end 55 projects outwardly from the second end 30 of the elongated nut 15. The threaded portion 25 of the elongated nut 15 is threaded into the spindle bar. The tool receiving portion 35 is received by a tool (not shown) to tighten the threaded portion 25 of the first end 20 into the spindle bar. The mating surface 65 of the flange 60 contacts the spindle bar and enables a smaller, more positive drive profile to be used such as a twelve-point drive profile 70 or a hex drive profile. The flange 60 and twelve-point drive profile 70 helps to reduce the total volume, weight, and cost of the elongated nut 15 while enabling consistent torque and nut retention due in part to a large contact area between the flange 60 and the spindle bar.

In operation, the spindle assembly 10 is engaged with the spindle bar of a cotton harvester (not shown) such that the cotton harvester spindle 45 rotates freely within the one piece elongated nut 15. Lubricant flows from inside the spindle bar, through the notches 90, 95, 100, and through the lubricant grooves 75, 80, 85 to lubricate the bearing portion 50 of the cotton harvester spindle 45.

The one-piece hard coat anodized elongated nut 15 provides significant weight reduction. The weight reduction decreases the load on a cam arm (not shown) and a cam roller of a unit (not shown), which allows for a faster drum speed and consequently a faster harvesting speed. The weight reduction also allows more units to be used while the hard coat anodizing prevents galvanic corrosion from occurring between the aluminum elongated nut 15 and the aluminum spindle bar.

FIG. 5 illustrates a cotton harvester spindle assembly 210 including an elongated nut 215 according to another embodiment. The spindle assembly 210 includes features similar to the spindle assembly 10 of FIGS. 1-4, and therefore, like components have been given like reference numbers plus 200 and only the differences between the spindle assemblies 10 and 210 will be discussed in detail below.

The spindle assembly 210 includes an elongated nut 215 having a lubricant cavity 300 positioned between a first end 220 of the elongated nut 215 and a second end 230. The lubricant cavity 305 is in fluid communication with a lubricant groove 275 and a notch 290. The lubricant cavity 305 is also in fluid communication with a lubricant groove 285 and a notch 300.

In operation, the spindle assembly 210 operates similarly to the spindle assembly 10 and only the differences will be discussed. Lubricant flows from inside the spindle bar, through the notches 290, 300, through the lubricant grooves 275, 285, and to the lubricant cavity 305.

Various features and advantages of the invention are set forth in the following claims.

1. A spindle assembly engageabie with a spindle bar of a cotton harvester, the spindle assembly comprising:
an elongated nut including,
a first end adjacent a threaded portion configured for receipt by the spindle bar;
a second end, opposite the first end, adjacent a tool receiving portion configured to be received by a tool to tighten the threaded portion adjacent the first end into the spindle bar;
an aperture extending through the elongated nut from the first end to the second end;
a lubricant cavity recessed into the aperture of the elongated nut, the lubricant cavity positioned between the first end and the second end; and
a cotton harvester spindle including a bearing portion rotatably supported by the aperture of the elongated nut and a picking end projecting outwardly from the second end of the elongated nut;
wherein the elongated nut is hard coat anodized to improve wear resistance.

2. The spindle assembly of claim 1, wherein the elongated nut is fabricated from aluminum.

3. The spindle assembly of claim 1, wherein the elongated nut is fabricated from magnesium.

4. The spindle assembly of claim 1, wherein the elongated nut is fabricated from a metal, or metal alloy, that is lighter than steel.

5. The spindle assembly of claim 1, further comprising a flange coupled to the tool receiving portion.

6. The spindle assembly of claim 5, wherein the tool receiving portion has a hex drive profile.

7. The spindle assembly of claim 5, wherein the tool receiving portion has a twelve-point drive profile.

8. The spindle assembly of claim 1, further comprising a lubricant groove extending along the aperture from the first end towards the second end.

9. The spindle assembly of claim 8, further comprising a notch in the first end in fluid communication with the lubricant groove.

10. (canceled)

11. A spindle assembly engagable with a spindle bar of a cotton harvester, the spindle assembly comprising:
an elongated nut including,
a first end adjacent a threaded portion configured for receipt by the spindle bar;
a second end, opposite the first end, adjacent a tool receiving portion configured to be received by a tool to tighten the threaded portion adjacent the first end into the spindle bar;
an aperture extending through the elongated nut from the first end to the second end;
a lubricant groove extending along the aperture from the first end towards the second end; and
a cotton harvester spindle including a bearing portion rotatably supported by the aperture of the elongated nut and a picking end projecting outwardly from the second end of the elongated nut;
wherein the elongated nut is hard coat anodized to improve wear resistance.

12. The spindle assembly of claim 11, wherein the elongated nut is fabricated from aluminum.

13. The spindle assembly of claim 11, wherein the elongated nut is fabricated from magnesium.

14. The spindle assembly of claim 11, wherein the elongated nut is fabricated from a metal, or metal alloy, that is lighter than steel.

15. The spindle assembly of claim 11, further comprising a flange coupled to the tool receiving portion.

16. The spindle assembly of claim 15, wherein the tool receiving portion has a hex drive profile.

17. The spindle assembly of claim 15, wherein the tool receiving portion has a twelve-point drive profile.

18. The spindle assembly of claim 11, further comprising a notch in the first end in fluid communication with the lubricant groove.

19. The spindle assembly of claim 11, further comprising a lubricant cavity positioned between the first end and the second end and in fluid communication with the lubricant groove.

20. A spindle assembly engageable with a spindle bar of a cotton harvester, the spindle assembly comprising:
an elongated nut including,
a first end adjacent a threaded portion configured for receipt by the spindle bar;
a second end, opposite the first end, adjacent a tool receiving portion configured to be received by a tool to tighten the threaded portion adjacent the first end into the spindle bar;
an aperture extending through the elongated nut from the first end to the second end;
a lubricant groove extending along the aperture from the first end towards the second end;
a notch in the first end in fluid communication with the lubricant groove;
a lubricant cavity positioned between the first end and the second end and in fluid communication with the lubricant groove; and
a cotton harvester spindle including a bearing portion rotatably supported by the aperture of the elongated nut and a picking end projecting outwardly from the second end of the elongated nut;
wherein the elongated nut is hard coat anodized to improve wear resistance.
